(19) United States
(12) Patent Application Publication
(10) Pub. No.: US 2009/0125743 A1
(43) Pub. Date: May 14, 2009

(54) Socket Assembly With Data Traffic Sensing

(76) Inventors: Peter S Robertson, Nottingham (GB); Ian R Browne, Kirkby-In-Ashfield / Nottingham (GB)

Correspondence Address: RYAN KROMHOLZ & MANION, S.C., POST OFFICE BOX 26618, MILWAUKEE, WI, 53226, US

(21) Appl. No.: 11/922,797

(22) PCT Filed: Jun. 21, 2006
(86) PCT No.: PCT/GB2006/002282

§ 371 Date: Nov. 17, 2008

(30) Foreign Application Priority Data
Jun. 21, 2005 (GB) 0512620.6

(51) Int. Cl. G06F 1/32

(52) U.S. Cl. 713/324

(57) ABSTRACT

A power distribution apparatus for use with a suite of master and peripheral devices, comprising a master electrical outlet and at least one slave electrical outlet, both connectable to a common electrical power supply. The apparatus further comprising a monitoring means for monitoring data traffic, e.g. USB bus signals, associated with a master device such as a personal computer, and a controller for interrupting power to the at least one slave electrical outlet in response to the monitoring means detecting a prescribed change in the data traffic of the master device.

The present invention relates to socket assemblies and their use in the supply of electrical power to suites of master and peripheral devices.

There are a number of electronic “master” devices (e.g. desk-top computers, workstations and computer-aided design terminals) that are capable of being connected to, and used in conjunction with, one or more “peripheral” devices such as printers, scanners and monitors. Although each peripheral device is only ever used in conjunction with the master device, it is often the case that each peripheral device requires its own connection to a power supply.

Although “trailing lead” socket bank assemblies provide a solution to the problem of how to provide sufficient numbers of power supply outlets for suites of master and peripheral devices, they do not address a further problem arising from such suites. That is, because each peripheral device is often independently connected to an outlet of the socket bank, each such device may need to be turned off or isolated from the mains supply separately. Where a number of different peripheral devices are connected to a master device, the user of that master device may not remember and/or wish to expend the effort to tam off all of the peripheral devices at the same time as the master device. The upshot of this can be that peripheral devices are left in operations or at lest connected to the mains supply, during periods when the ater device is not in use. The consumption of electrical power by the peripheral devices during such periods can cause unnecessary expense for the user. Moreover, wasting energy can ultimately have a negative effect on the environment, by requiring additional consumption of fossil fuels etc.

The problem of controlling power to a suite of master and peripheral devices has been addressed by the socket assembly described in granted patent GB2398441, in the name of Peter Robertson. Using this assembly, peripheral devices can be powered down (i.e. turned off) when a change in operating state of the master device is sensed, by monitoring the power drawn through a master electrical outlet of the socket assembly, thereby allowing the whole suite of devices to be turned off when the master device is turned off, or placed into a standby state.

However, for certain types of master device, it may at times be desirable to assess whether a change in operating state of the master device has occurred by inspecting other ‘change-of-state’ indicators, instead of, or in addition to, sensing changes in power. For example, power sensing techniques may not be the most suitable for master devices which have closely separated power consumption levels or overlapping ‘on’ and ‘standby’ power consumption ranges.

In the case of computing master devices, one useful change-of-state indicator is provided by monitoring data traffic on an internal bus, such as a universal serial bus (USB). When the computer is active (i.e. ‘on’) data traffic will flow across the USB, as USB peripheral devices (such as keyboards, mice, scanners and printers etc.) communicate with the central processing unit (CPU). However, when the computer is tuned off, USB data traffic obviously ceases.

Therefore, by monitoring the data traffic on the USB for instance, it is possible to determine whether, and at which point, the master device undergoes a change in operating state, without necessarily sensing a change in the power consumption of the master device.

A common disadvantage presented by suites of master and peripheral devices is that, in the particular case of a computing suite for instance, the computer usually includes insufficient interface ports for the number of peripheral devices required to be connected. Hence, typically, multi-way adaptors, multi-port hubs and extension leads may all be commonly used to supplement the deficiency in interface ports, all of which may add further complexity to connecting the suite of devices. Moreover, a plurality of adaptors, hubs and leads also increases the amount of space occupied by the suite of devices, as well as adding to the number of trailing cables and hardware components required in the environment of the suite. This may be impractical, and costly, for the typical user and can be aesthetically unpleasing, particularly in a home or office environment. Furthermore, a prevalence of trailing cables can be dangerous, especially if routed across a floor, since the chances of accidental tripping of a user are increased significantly.

A further problem encountered by users of suites of master and peripheral devices, is that it is generally not possible to directly monitor the power consumption and power usage characteristics of the master and peripheral devices themselves. This problem can be particularly disadvantageous to users of certain devices (e.g. computers and computer peripherals), since it can be useful to monitor power consumption so as to (i) estimate the cost of power consumption, and (ii) to determine if one or more of the devices are beginning to exhibit anomalistic power variations due to a failing component. The ability to monitor power consumption could lead to cost savings and/or provide early warning of potential problems, so as to avoid fixture damage to a device, which may be costly to repair or else require a replacement device to be purchased.

In the present invention we describe an improved power distribution apparatus, which is capable of monitoring data traffic in an associated master device, so as to determine changes in the operating state of that master device. The power distribution apparatus also hog multi-functional capabilities, which we have found solves some or all of the above-mentioned problems.

According to one aspect of the present invention there is provided a power distribution apparatus comprising:

a master electrical outlet and at least one slave electrical outlet, both connectable to a common electrical power supply;

monitoring means for monitoring data traffic associated with a master device; and

a controller for interrupting power to the at least one slave electrical outlet in response to the monitoring means detecting a prescribed change in the data traffic of the master device.

According to another aspect of the present invention there is provided a method of power distribution comprising the steps of:

supplying electrical power to a master electrical outlet and at least one slave electrical outlet via a common power supply;

monitoring, via a monitoring means, data traffic associated with a master device; and

interrupting the power to the at least one slave electrical outlet, via a controller, in response to the monitoring means detecting a prescribed change in the data traffic of the master device.

Embodiments of the present invention will now be described by way of example and with reference to the accompanying drawings in which:

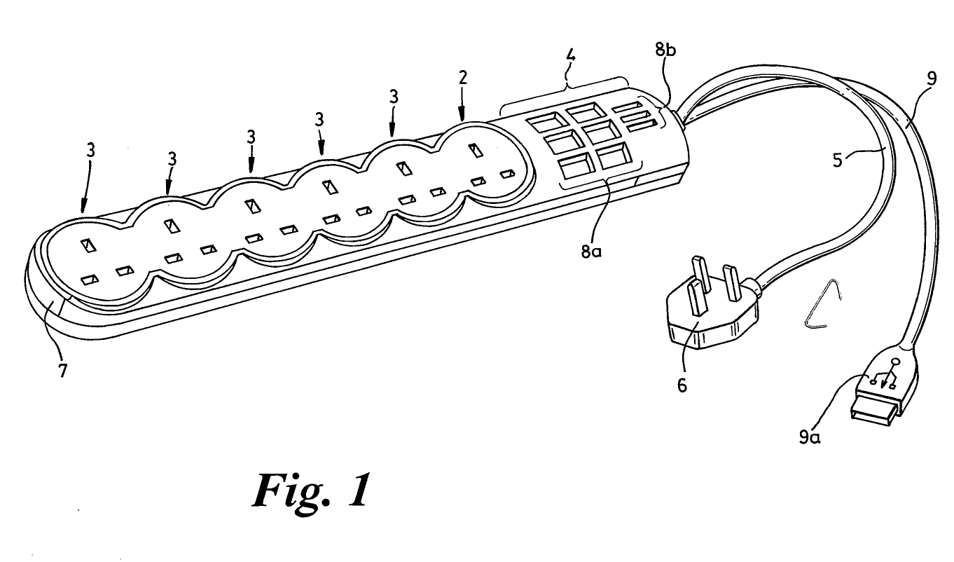

FIG. 1 is a schematic representation of the power distribution apparatus of the present invention according to a preferred arrangement.

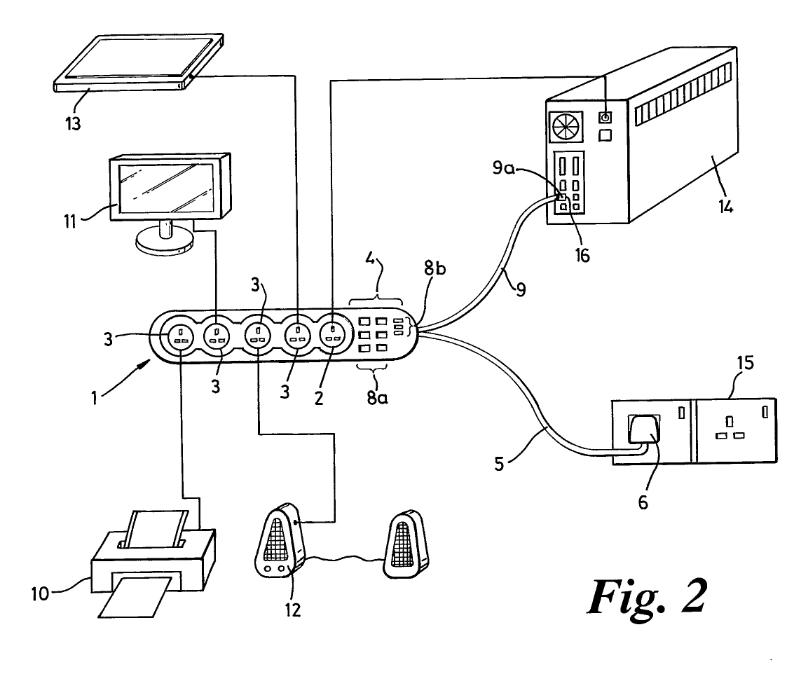

FIG. 2 is a schematic representation of the apparatus as shown in FIG. 1 arranged for use with a typical computing suite of devices.

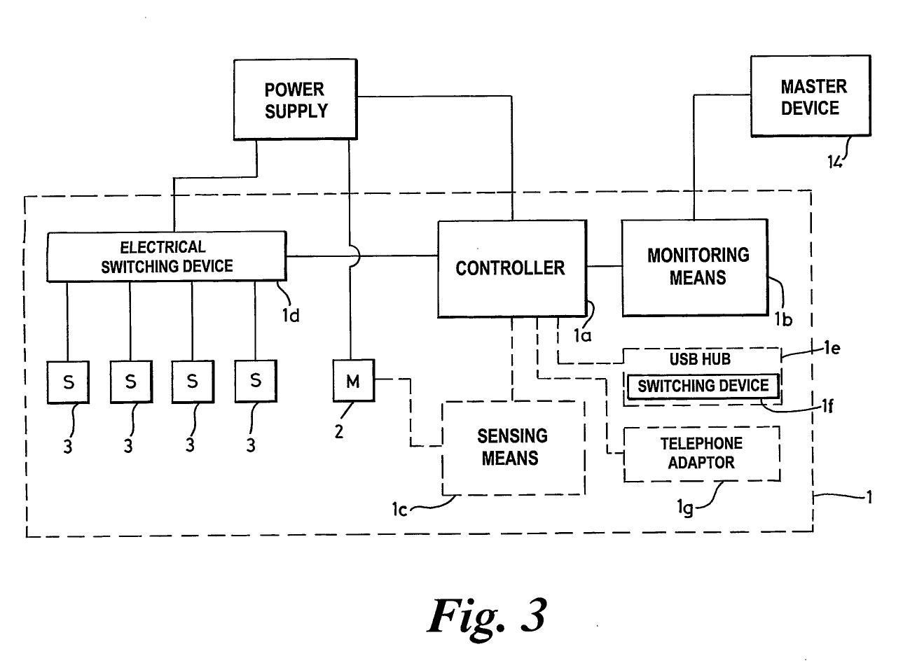

FIG. 3 is a schematic representation of the power distribution apparatus of FIG. 1 shown in use with a typical master device.

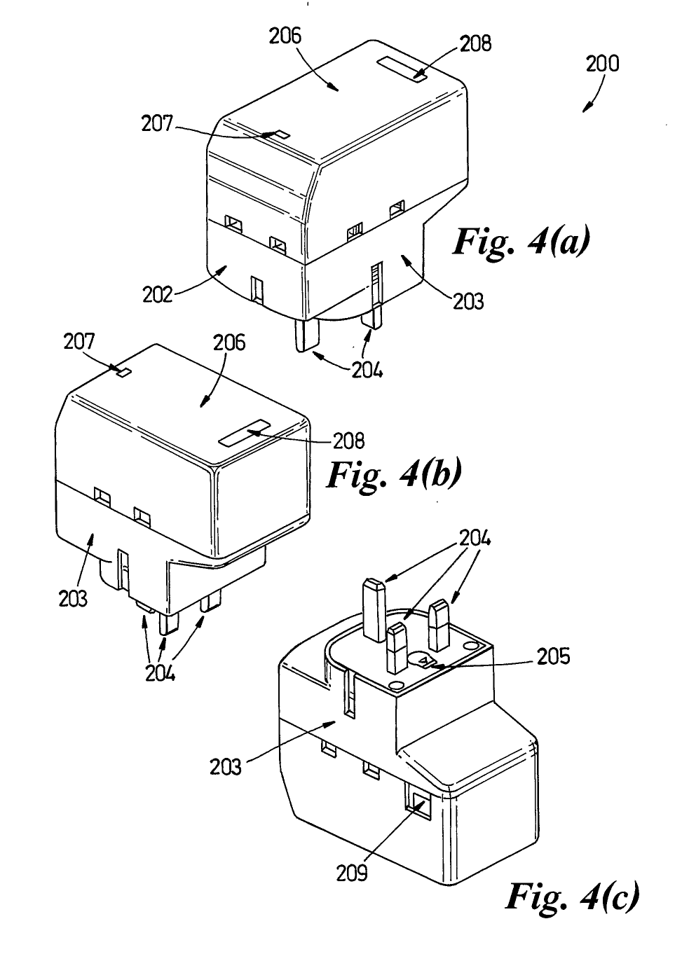

FIGS. 4(a)-(c) are perspective views of an alternative arrangement of the power distribution apparatus of the present invention.

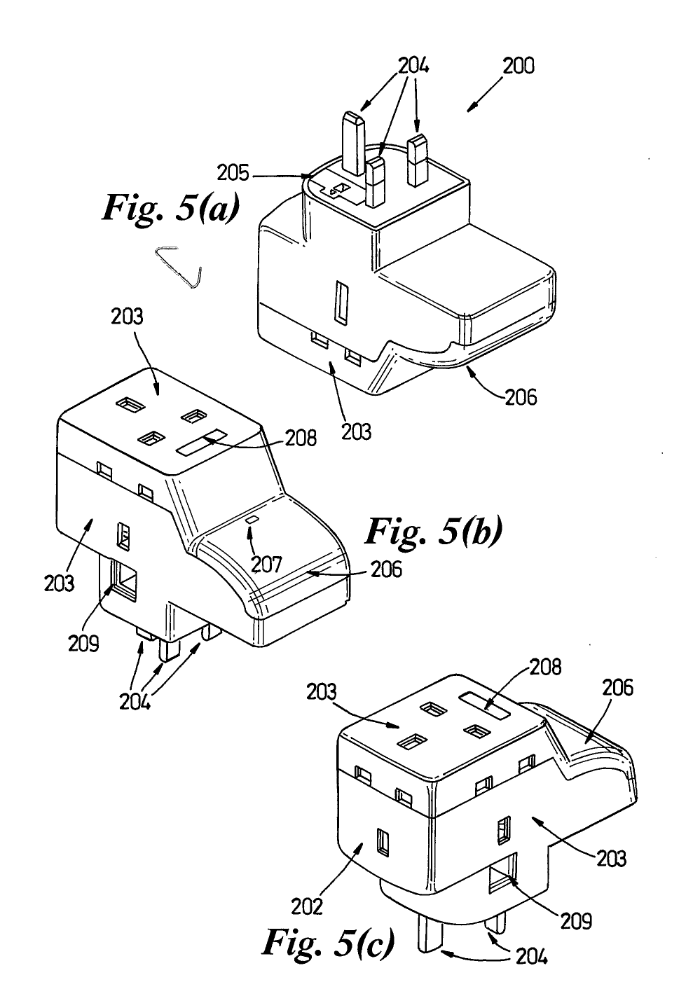

FIGS. 5(a)-(c) are perspective views of another alternative arrangement of the power distribution apparatus.

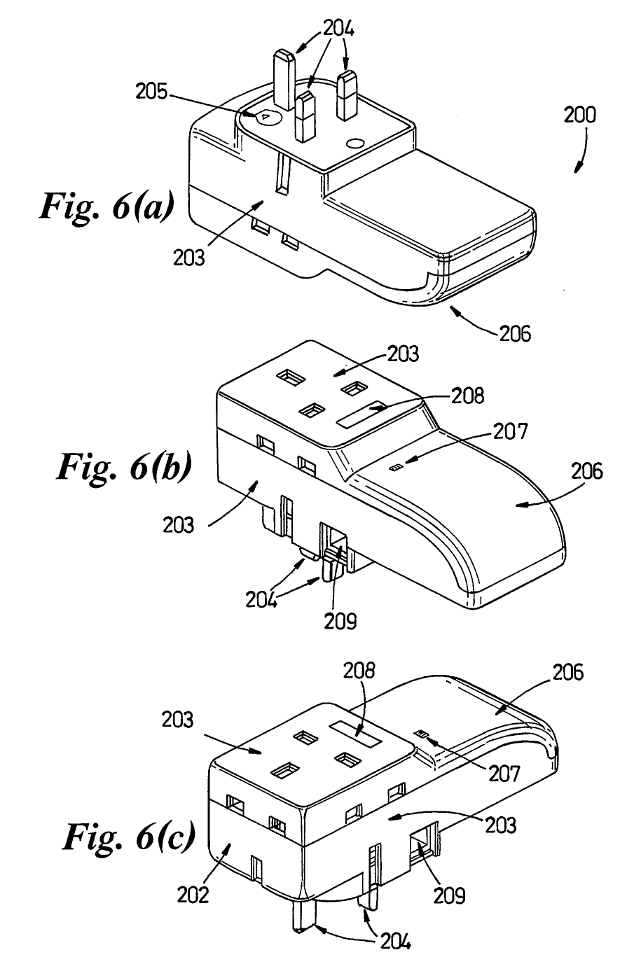

FIGS. 6(a)-(c) are perspective views of another alternative arrangement of the power distribution apparatus.

With reference to FIGS. 1 and 3 there is shown a power distribution apparatus according to a particularly preferred arrangement of the present invention, comprising a socket bank 1, including at least one master electrical outlet 2 and one or more slave electrical outlets 3. An internal controller 1a is located inside the region designated by 4 and a lead 5 provides an electrical connection between the controller and a plug 6, which is of a type suitable for use with electrical mains sockets.

In preferred arrangements, the controller 1a is based on a microprocessor circuit that is capable of supplying or interrupting electrical power to the slave electrical outlets 3, while providing continuous electrical power to the maser electrical outlet 2. The microprocessor is preferably of a type that can be directly programmed (e.g. PIC).

A controller suitable for use with the present power distribution apparatus is described in granted patent GB2398441 in the name of Peter Robertson, modified in accordance with the prescribed improvements of the present invention.

In the preferred arrangement of FIG. 1, a cable 9 is provided which enables the socket bank 1 to be electrically connected to a master device, such as a computer, so as to allow a monitoring means 1b to monitor data traffic associated with the master device 14.

In preferred arrangements, the cable 9 is a flexible, electrical cable of a type suitable for connection to a standard USB port on a computer, and therefore terminates at its distal end with a standard A-type (i.e. male) USB connector 9a.

The cable 9 is preferably permanently attached to the socket bank 1 at its proximal end, or may alternatively be detachable. Any suitable length of cable may be used, although in USB arrangements, the cable length is preferably less than about 5 m to avoid undue signal degradation within the cable.

It is to be appreciated that the cable 9 mar be any suitable electrical cable or lead having an appropriate distal end connector for insertion into a reciprocally shaped port of the computer, and therefore may include cables such as serial port, RS232, parallel port, Firewire and LAN (e.g. Cat5 UTP) cables. Alternatively, in laptop arrangements, the cable 9 may be inserted into any suitable reciprocally shaped port of a docking port or station etc.

In alternative arrangements, the controller 1a may be adapted to include a conventional transceiver and therefore, the socket bank 1 may be coupled to the master device 14 using wireless communications, instead of a cable connection. For example, in the case of a computing master device, a USB dongle could be inserted into a free USB port so as to allow communication between the computer and the controller using any of the standard wireless protocols, e.g. WiFi and Bluetooth.

By ‘data traffic’ we mean any electronic data signals, whether digital or analogue, convey ing instructions and commands etc. in or from a master device which can be directly monitored by the monitoring means of the present apparatus. For example, in USB arrangements, the data traffic comprises data strings and device commands, including bus re-set and diagnostic signals, which appear on the USB.

The master device 14 may be any electronic device that undergoes a change in operating state giving rise to corresponding changes in the data traffic, which are detectable by the monitoring means 1b. As such, master devices include those that are capable of producing, or being adapted to produce, a change in the data traffic as a consequence of, for example, turning “on”, turning “off”, and entering or exiting a standby state.

The master device 14 will typically be associated with one or more peripheral devices, for example, as in a computing suite comprising a printer, scanner, modem and monitor etc. When used herein, the term “peripheral devices” is taken to include electronic devices that operate in conjunction with the master device 14 (e.g. by sending to and/or receiving from the master device a signal and/or data) in order to perform a function. It is to be appreciated however, that some peripheral devices may also be associated with a master device, but need not be in communication with the master device, for example, such as a desk lamp or paper shredder forming part of a computing suite. In this case, it could also be desirable to turn these devices off when the computing suite is no longer in use.

Referring to FIG. 2, there is shown a preferred arrangement of the socket bank 1 arranged for use with a typical computing suite of devices, including a printer 10, monitor 11 (e.g. CRT, TFT etc.), speakers 12 and flatbed scanner 13. Preferably, the power lead (shown diagrammatically) of the computer 14 is inserted into the master electrical outlet 2 and electrical power for the device is drawn from that outlet. The master electrical outlet 2 is available to supply electrical power whenever the socket bank 1 receives electrical power from the mains electrical outlet 15, via plug 6 and lead 5.

It is to be appreciated that the socket bank 1 may be adapted to supply electrical power derived from any suitable power supply to the master electrical outlet 2 and the slave electrical outlets 3. Suitable power supplies may include a battery, a generator or, most preferably, the mains, as shown in FIG. 2.

In other arrangements, the computer 14 may alternatively be powered by connection to a mains electrical outlet, such as outlet 15, and therefore need not receive power via the socket bank 1. However, in this case it is not possible to sense changes in the power consumption of the computer 14, should the user wish to supplement data traffic monitoring with power sensing techniques (as described later).

In particularly preferred arrangements, the socket bank 1 is connected to the computer 14 via USB cable 9, by inserting connector 9a into a free USB port 16 on the computer 14. The USB port may be any suitable front or rear mounted port (as shown in FIG. 2), or alternatively could be a free port in a USB hub attached to the computer 14.

When the socket bank 1 is connected to the computer 14 in this way, the controller is preferably presented to the USB of the computer 14 as a ‘dummy’ device. Therefore, the computer 14 will become aware that the socket bank 1 has been connected (e.g. via conventional plug and play techniques) and will extend all usual USB protocols to the socket bank 1. The controller is preferably configured so as to perform USB ‘hand-shaking’ routines, so as to establish itself as a USB peripheral device, permitting bi-directional communication between it and the computer 14.

Having established a connection between the controller and USB of the computer 14, the monitoring means 1b may commence monitoring the data traffic on the USB. The monitoring means 1b may preferably form part of the controller circuitry, or else can be a separate module coupled to the controller 1a.

The monitoring means 1b may be any suitable electronic device for sensing electrical signals associated with the data traffic, and as such may be based on digital or analogue current and/or voltage sensing devices.

During normal use of the computing suite of devices as shown in FIG. 2, the CPU of computer 14 will send communications to the USB peripheral devices, such as the printer 10 and scanner 13, via the USB. The communications may be instructions or commands to perform a particular function, e.g. print or scan, or else may simply be diagnostic “I'm alive” or hand-shaking signals (herein ‘alive signals’), to determine whether the peripheral devices are still present and functioning normally.

The monitoring means 1b detects the corresponding data traffic on the USB, and informs the controller 1a that data traffic is present on the bus.

The simplest switching condition that the controller 1a can implement, is to interrupt the power to the slave electrical outlets 3 when the monitoring means 1b detects ht the data traffic on the bus completely ceases (i.e. when the computer is off). Therefore, when the data traffic flow decreases to zero, the peripheral devices may be correspondingly powered down.

However, the data traffic will only actually completely cease when the computer 14 is turned off, as the computer 14 and peripheral devices 10 and 13, for instance, may continue to exchange alive signals, even when the computer 14 is in a standby state and no instructions are explicitly issued to the devices. Therefore, it may be necessary to implement a further switching condition for when the computer is placed into a standby state (either directly or as a result of inactivity).

Accordingly therefore, the controller 1a is preferably configured to also interrupt power to the slave electrical outlets 3, when no signals other than alive signals are detected over a prescribed period of time and no other data traffic is detected on the bus, therefore corresponding to the standby state of the computer 14. The prescribed period of time is preferably in the range of about 50 ms to about 5 minutes.

The controller 1a may also preferably be configured to interrupt power to the slave electrical outlets 3, when the monitoring means 1b detects one or more particular signals within the monitored data traffic. In the case of USB arrangements, the CPU of computer 14 transmits a bus re-set signal or a shut-down signal on the USB during its nodal standby/shutting down procedure. Therefore, the monitoring means 1b could be configured to respond to such a signal and notify the controller 1a accordingly.

Hence, the controller 1a of the present invention is preferably configured to perform switching of the slave electrical outlets 3, based on the rate and/or composition of the data traffic.

Therefore, when the controller 1a decides that the computer 14 has undergone a change in operating state it will act to interrupt the supply of power to the slave electrical outlets 3, thereby any peripheral devices to be powered down. In this way, the whole suite of devices (as shown in FIG. 2) can be turned off in response to the user shutting down computer 14.

Conversely, the controller 1a will act to re-connect the slave electrical outlets 3 to the common power supply, when the monitoring means 1b detects an increase in the rate of data traffic (e.g. from zero) and/or when the composition of the data traffic changes, for instance, when a bus initialisation signal or start-up signal is detected.

In preferred arrangements, the controller 1a can be configured to vary the timescale over which the switching of the slave electrical outlets 3 takes place.

Hence, the slave electrical outlets 3 can be connected to the common power supply substantially immediately after the controller 1a determines that the master device has undergone a change in operating state; while the interruption of power to the slave electrical outlets 3 may be delayed using a suitable conventional timing circuit.

This functionality can be particularly advantageous in computing suites of devices, as peripheral devices generally need to be available soon after the computer is turned on, while the computer's shutting down procedure typically requires a short interval of time in order to terminate hand-shaking agreements etc. with the peripheral devices before they are turned off.

The controller 1a is preferably configured therefore, to wait for a predetermined interval of time, after the detection of a change in operating state of the master device 14, before interrupting the power to the slave electrical outlets 3. The predetermined interval of time is preferably in the range of about 0.5 seconds to about 20 seconds, but may be shorter or longer depending on the desired application.

In particularly preferred arrangements, the power distribution apparatus may further comprise a sensing means 1c for sensing the power drawn from the master electrical outlet 2 by a connected master device, in order to assess whether a change in operating state has occurred. Of course, in these arrangements, it is necessary for the master device to be powered from the socket bank 1, and not an external supply.

The operating states of the master device ideally correspond to distinct power consumption levels, the levels therefore being characteristic of the power requirements of that particular master device. Any change in the operating state of the master device ideally produces a corresponding change in the level of power consumption and data traffic flow and/or composition.

A sensing means and power sensing arrangement for use with the present apparatus is described in detail in co-pending GB application titled “An Improved Sensing Socket Assembly”, in the name of Peter Robertson, modified in accordance with the preferred arrangements.

Therefore, the power distribution apparatus of the present invention may be operated in two modes: (i) data traffic sensing, and (ii) data traffic sensing with power seeing, depending on the desired application and particular suite of devices.

In preferred arrangements, the slave electrical outlets 3 are connected to the common power supply by forming an electrical connection between the slave electrical outlet 3 and the live power rail. Preferably, the controller controls a suitable electrical switching device 1d adapted for use in forming the electrical connection between the slave outlet and the live power rail.

The electrical switching device 1d may be any suitable device that is capable of making or breaking an electrical connection via either physical means or an electrically controlled conducting medium. As such, preferred devices include a bi-directional gate controlled thyristor (i.e. a triac) and a relay of the solid state or, preferably, the electromechanical variety.

Arrangements for forming an electrical connection between the slave electrical outlets 3 and the power supply are described in granted patent GB2398441 and any of these known arrangements may be used in the power distribution apparatus of the present invention.

The power distribution apparatus is preferably provided with surge protection (i.e. protection against damage by transient high voltages arising from the electrical power supply). This may be achieved by using techniques and methods known to those skilled in the art.

The power distribution apparatus may also be provided with a visual notification means operable to indicate supply of electrical power to the master electrical outlet 2 and/or the at least one slave electrical outlet 3.

Referring again to FIGS. 1 and 3, there is shown in the region generally denoted by 4, an interface of the socket bank 1, which may include a plurality of standard interface ports and connectors 8a, 8b.

It is to be appreciated that the interface is compatible with each of the preferred arrangements, and that the illustration in FIG. 1 is not intended to be limiting. Hence, the plurality of standard interface ports and connectors 8a, 8b may reside on any part of the external source of the socket bank 1, in any suitable configuration.

The interface ports and connectors 8a, 8b may form part of the controller circuitry, or else can be fabricated as a separate module which is coupled to the controller 1a.

In preferred arrangements, the interface is a standard USB hub 1e, including a plurality of standard USB interface ports 8a, each suitable for connection to a USB peripheral device. Preferably the ports 8a are accessible via at least one face of the outer casing of the socket bank 1.

The USB hub 1e is preferably connected to a computer through the cable 9, which is also used by the monitoring means 1b to monitor the data traffic. Alternatively, the USB hub 1e may be connected to the computer via a different USB cable (not shown), which is either permanently, or detachably, connected to the socket bank 1.

The inclusion of a USB hub 1e is advantageous, since in the case of a computing suite of devices, an integrated hub is able to solve the problem of insufficient interface ports, which is a common disadvantage in computing suites of the type as illustrated in FIG. 2.

In other arrangements, the interface may include one or more standard telephone jack connectors 8b, preferably arranged as a multi-way telephone socket adaptor 1g, each connector suitable for connection to a telecommunications device, such as, but not limited to, a telephone, modem or fax machine.

It is to be appreciated that arrangements including a USB hub 1e and those including a multi-way telephone adaptor 1g are not exclusive, and that arrangements in which the socket bank 1 includes both a hub and an adaptor are also preferred, and are in accordance with the present invention.

The USB hub 1e may also comprise a switching device 1f, preferably an electromechanical relay circuit which is capable of isolating the peripheral devices which are connected to the ports of the USB hub 1e from the hub power supply (which is provided by the USB port on the computer), in response to the controller 1a determining that the master device 14 has turned off or else has entered a standby state. This arrangement can be particularly advantageous for computers in which the USB ports remain ‘high’ (i.e. the output voltage stays on) after the computer has shut down, since the hub 1e will remain powered but the peripherals can still be correspondingly tuned off.

In accordance with other preferred arrangements, one or more of the slave electrical outlets 3 could be adapted to be independently addressable, so that the controller 1a can instruct only certain outlets to switch on and off. Preferred switching sequences may be programmed into the controller 1a via a suitable control application, executing on the connected computer. In this way, the switching of peripherals can be uniquely tailored to the particular suite of devices.

For example, in a computing suite, it may be desirable for the slave electrical outlet to which a fax modem or network router is connected to remain powered when the computer is turned off. Hence, a user can instruct the controller 1a via a suitable device driver (e.g. USB) not to isolate this particular slave outlet when the computer undergoes a change in operating state.

Preferably, the control application includes a graphical user interface which allows one or more slave outlets 3 to be designated as switchable or non-switchable etc. depending on the desired requirements, which is then communicated to the controller preferably via the cable 9.

The user may therefore configure the socket bank 1 to his/her own particular requirements, depending on the desired application and/or types of master and peripheral devices. The controller 1a may be adapted to retain the programmed instructions in a non-volatile memory, so that the designated slave outlets operate in the desired way even following an interruption of power to the socket bank 1.

It is to be appreciated that any suitable control application may be executed on the computer in order to configure the outlets and/or issue commands to the controller 1a so as to implement preferred switching sequences or to directly turn a particular peripheral device on or off.

Alternatively, the controller 1a may be controlled via a command line application using a suitable keyword protocol, which is interpreted by the controller 1a so as to configure and/or switch the one or more slave electrical outlets 3.

In other arrangements, there may be two or more master electrical outlets, so as to receive further master devices. Increasingly in computing suites of devices for instance, there may be two or more computers linked by a KVM (keyboard, video, mouse) switch, that share the same peripheral devices. Therefore, it is necessary to configure the socket bank 1, such that the peripheral devices are turned on when either of the master devices are active. Hence, the controller can be programmed in the manner of the foregoing arrangements, to connect the slave electrical outlets 3 to the power sly when either of the master devices undergo a change of operating state.

Each of the master electrical outlets would operate as described in the foregoing arrangements, however the slave electrical outlets 3 would only be isolated from the common power supply when both master devices turn off or else enter a standby state, either simultaneously or successively.

In particularly preferred arrangements, the controller 1a is also adapted to provide a serial data stream comprising one or more power consumption statistics, based on the power drawn from each master electrical outlet 2 and/or each slave electrical outlet 3. This data stream may then be provided to the computer via the cable 9, where an event logger application interprets the statistics and provides analysis and/or graphical output illustrating the power consumption from the socket bank 1 over a desired timescale.

The event logger may be any computer execrable application suitable for interpreting the data stream and presenting statistical analysis to a user on a display device on the computer. Preferably, the event logger compiles a batch of historical power consumption data, which is then stored on a non-volatile storage device of the computer, e.g. a hard drive.

By monitoring the power consumed by a master device and/or any peripheral devices connected to the socket bank 1, it is possible to determine the power usage characteristics of the individual devices, which can be advantageous in estimating the overall cost of operating the suite of devices, and may also be helpful in identifying any current problems with the devices.

The event logger may preferably receive the one or more power consumption statistics in real-time, for direct viewing, or alternatively, periodically as a batch of historical data, to be viewed retrospectively.

Although the socket bank 1 is ideal for managing the provision of power to a suite of devices, comprising one or more master devices and a plurality of peripheral devices, the controller may preferably be further adapted so as to communicate with other socket banks of the present invention via mains signaling. E this way, a network of socket banks 1 can be created within a home or office environment.

The controller 1a can be modified to include a transceiving circuit, which is able to send a pulsed signal via the mains electrical (ring) circuit to instruct other socket banks to power down their respective master and/or peripheral devices. For example, a user working on a computer in a first floor study, could configure a network of socket banks 1 around his/her home, such that when the computer is turned off at the end of the day, all the other devices throughout the home (which are connected to respective socket banks) are also turned off. Therefore, the user need not physically enter the rooms of the home to turn off his/her devices.

Preferably, the socket banks are individually configurable, so that only those socket banks having devices which are desired to be turned off, would respond to the pulsed signal. Hence, the respective controllers could be programmed to respond to pulsed signals or else to ignore them, depending on their location within the home or office etc.

In alternative arrangements, the socket banks 1 could be adapted to communicate via wireless protocols, such as, but not limited to, WiFi and Bluetooth.

Although the preferred arrangements have been described in relation to USB data traffic sensing and USB connectivity, it is to be appreciated that one or more of the principles of the present invention are consistent with other port and bus architectures, such that the monitoring means may be adapted to monitor the data traffic at one of the serial, parallel, RS232, Firewire and local area network (LAN) ports, and/or at one of the ISA and PCI busses.

Moreover, the monitoring means 1b may be adapted to monitor wireless data traffic between the computer 14 and one or more of the peripheral devices. For instance, in computing suites, the computer may communicate with a wireless router or ADSL modem etc., using one of the standard wireless protocols, e.g. WiFi or Bluetooth etc. The monitoring means 1b could monitor any changes in the wireless communications, so as to determine whether the computer has undergone a change in operating state. Preferably, the monitoring means 1b could be adapted to monitor multiple wireless communication channels, e.g. between computer and router and computer and wireless adapted printer etc., such that it would only identify a change in operating state if two or more, or all, channels indicated that data traffic had ceased. In this way, incorrect switching of the peripherals due to failure of an individual device, or error on the channel, could be avoided.

The above technique may also be adapted for use in ‘hardwired’ LANs, such that the monitoring means 1b could monitor the network data traffic on one or more wired communication channels.

Although the power distribution apparatus of the present invention has been described in relation to a trailing socket bank 1, it is to be appreciated that the physical arrangement of the master and slave electrical outlets can be configured into any suitable 3-dimensional geometrical shape and structure. Therefore, according to the present invention, there are shown in FIGS. 4-6, example arrangements in which the power distribution apparatus has been configured into a substantially ‘cubic’ socket assembly, thereby offering considerable space saving advantages and convenience of use.

It is to be understood that these examples are not limiting, and therefore each serves as an illustration of one possible cubic configuration that may be adopted by the power distribution apparatus of the present invention.

Referring to FIGS. 4(a)-(c), there are shown different views of a particularly preferred arrangement of the power distribution apparatus 200 (hereinafter referred to as the ‘socket cube’). In this arrangement, there is one master electrical outlet 202 and two slave electrical outlets 203, each disposed on a respective orthogonal face of the socket cube 200. The slave electrical outlets 203 are mounted on either side of the socket cube 200, with the master electrical outlet 202 being located on an orthogonal face therebetween.

For ease of use and reference for the user, the master electrical outlet 202 can be coloured coded and/or marked in some way, e.g. by applying a suitable paint or permanent transfer etc. to the corresponding face of the socket cube 200. In this way, the chances of the user inadvertently plugging a master device into a slave electrical outlet 203 can be significantly reduced.

The socket cube 200 includes integral electrical pin connectors 204, to permit insertion into a mains power supply socket. The pins 204 provide power to the master electrical outlet 202 and selectively to the slave electrical outlets 203, in accordance with the operation of the present controller. The master and slave electrical connections (i.e. power rails) are enclosed within the socket cube 200, and a mains rated use 205 is included for electrical safety purposes.

For additional safety, the apertures associated with the master and slave electrical outlets 202, 203 may be covered by internal, retractable shutters, which mechanically retract whenever a master or slave device is inserted into a respective outlet. In his way, the chances of inadvertently touching a power rail can be further minimised when inserting or removing devices. Moreover, the shutters provide an additional advantage that dust and other debris is prevented from getting inside of the socket cube 200 when not in use.

Referring again to FIG. 4(a), the area generally designated by 206 contains the internal controller, as described in detail in relation to the previous arrangements. The physical configuration of the controller will be understood to be dependent on the particular size and shape of the socket cube 200. Therefore, the configuration of the controller may differ slightly between different arrangements, depending on the components used.

A detachable cable (not shown) is provided with the socket cube 200, which enables the cube to be electrically connected to a master device for monitoring data traffic as described in relation to the preceding arrangements. The cable may be any suitable electrical cable or lead having an appropriate distal end connector for insertion into a reciprocally shaped port of the master device. For instance, as discussed earlier, in the example of a computer master device, the cable may be a serial, RS232, Firewire, LAN or USB cable type.

For example, in FIG. 4(c) the socket cube 200 is illustrated as including a RJ11 connector 209. This connector type can provide a connection to a LAN network adaptor card using a CAT5/6 UTP cable type. In this way, the data traffic associated with network communication can be monitored and used to control the switching of the socket cube, as described in relation to previous arrangements.

It should be appreciated that although the preferred socket cube arrangements make use of a detachable cable, a permanently connected cable is also consistent with other arrangements of the socket cube.

To provide the user with a visual indication that the socket cube 200 is in use, a LED 207 is mounted on a surface of the cube. This can optionally be turned on whenever the cube receives power or only when a master device is inserted into the master electrical outlet 202. To permit easy viewing, the LED 207 is located on an outwardly facing surface of the cube (e.g. on a face substantially opposite to the pin connectors). Additional LEDs may be included to indicate the power status of the attached slave devices etc.

In accordance with earlier arrangements, the socket cube 200 can also include an infra-red sensor 208 which permits remote control of the cube via a suitable hand held device etc. Alternatively, other sensor types may be used including optical, ultrasonic and wireless (e.g. WiFi, Bluetooth). As shown in FIG. 4(a), the sensor 208 is mounted on the cube face that is opposite to the electrical pin connectors 204 (i.e. outwardly facing), so as to provide the widest angular coverage for detection of transmitted signals.

Referring to FIGS. 5 and 6, there are illustrated other arrangements of the socket cube 200, with like features being labelled consistently with FIG. 4. In these arrangements, the socket cube comprises a elongated portion, denoted generally by 206, in which is housed the internal controller. In this way, additional space can be provided for a further outlet socket which may be an additional master 202 or another slave electrical outlet 203, as shown.

Other arrangements are taken to be within the scope of the accompanying claims.

1. A power distribution apparatus comprising:
a master electrical outlet and at least one slave electrical outlet, both connectable to a common electrical power supply;
monitoring means for monitoring data traffic associated with a master device; and
a controller for interrupting power to the at least one slave electrical outlet in response to the monitoring means detecting a prescribed change in the data traffic of the master device.

2. The apparatus of claim 1, wherein the monitoring means is adapted to monitor the data traffic on a USB bus of the master device.

3. The apparatus of claim 2, wherein the data traffic includes USB control signals and/or commands.

4. The apparatus of claim 3, wherein the prescribed change in data traffic corresponds to a decrease in the traffic from a first, higher data traffic rate to a second, relatively lower data traffic rate.

5. The apparatus of claim 3, wherein the prescribed change in data traffic corresponds to the transmission of one or more predetermined data signals.

6. The apparatus of claim 5, wherein the predetermined data signals include at least one of a re-set signal and a shut-down signal.

7. The apparatus of claim 6, wherein the controller is adapted to wait for a predetermined interval of time, after detecting said prescribed change, before interrupting the power to the least one slave electrical outlet.

8. The apparatus of claim 7, wherein the predetermined interval of time is in the range of about 0.5 seconds to about 20 seconds.

9. The apparatus of claim 8, wherein the apparatus further comprises a sensing means for sensing the power drawn from the master electrical outlet by the master device.

10. The apparatus of claim 9, wherein the controller is configured to determine whether the master device has undergone a change in operating state based on sensed changes in the power drawn from the master electrical outlet.

11. The apparatus of claim 1, wherein the monitoring means remotely monitors the data traffic via wireless communications.

12. The apparatus of claim 9, wherein the controller is adapted to be programmable, so as to control the sequence in which the slave electrical outlets are to be switched.

13. The apparatus of claim 12, wherein the controller is operable to independently control the switching of each slave electrical outlet.

14. The apparatus of claim 13, wherein the controller includes an electrical switching means for isolating or connecting each slave electrical outlet to the power supply.

15. The apparatus of claim 14, further comprising a USB hub including a plurality of standard USB interface ports, each suitable for receiving a USB peripheral device.

16. The apparatus of claim 15, wherein the USB hub includes an electrical switching means for isolating each USB interface port from the hub power supply, in response to the monitoring means detecting the prescribed change in the data traffic of the master device.

17. The apparatus of claim 16, wherein the controller includes a transceiver for sending/receiving switching signals to other controllers via mains signalling techniques.

18. The apparatus of claim 17, wherein the controller is adapted to provide a data stream comprising one or more power consumption statistics.

19. The apparatus of claim 18, further comprising an event logger operable to receive the data stream and to interpret the statistics for providing analysis and/or a graphical output.

20. The apparatus of claim 19, wherein the event logger is adapted to receive the power consumption statistics in real-time or periodically as a batch of historical data.

21. The apparatus of claim 2, wherein the controller is configured so as to appear to the USB bus as a “dummy” device.

22. The apparatus of claim 2 or 19, wherein the apparatus further comprises a standard USB lead for connecting the apparatus to the master device.

23. The apparatus of claim 1, wherein the monitoring means is adapted to monitor the data traffic at one of the following ports, serial, parallel, RS232, Firewire and LAN and/or one of the following busses, ISA, PCI and USB.

24. A method of power distribution, comprising the steps of:
supplying electrical power to a master electrical outlet and at least one slave electrical outlet via a common power supply;
monitoring, via a monitoring means, data traffic associated with a master device; and
interrupting the power to the at least one slave electrical outlet, via a controller, in response to the monitoring means detecting a prescribed change in the data traffic of the master device.
